(19) United States
(12) Patent Application Publication
(10) Pub. No.: US 2009/0125283 A1
(43) Pub. Date: May 14, 2009

(54) Method and apparatus for automatically determining compliance with building regulations

(76) Inventor: David Conover, Washington, DC (US)

Correspondence Address: BINGHAM MCCUTCHEN LLP, 2020 K Street, N.W., Intellectual Property Department, WASHINGTON, DC, 20006, US

(21) Appl. No.: 12/232,841

(22) Filed: Sep. 25, 2008

Related U.S. Application Data
(60) Provisional application No. 60/960,355, filed on Sep. 26, 2007.

(51) Int. Cl. G06F 17/50

(52) U.S. Cl. 703/1

(57) ABSTRACT

A protocol and software program are provided to create tagged representations of model building construction codes that have a tagging schema that reflects the logic and requirements of the codes from the text of the codes. The protocol and software can also be used to create “smart” versions of Federal, state, and locally adopted versions of the those codes, as well as reference standards and any other rules or regulations. The SMARTcodes™ and embedded schema and tags are usable by model checking software (MCS) as a limiting set of constraints when the MCS reads a building information model (BIM) that contains information about a building to check the building against the SMARTcodes™ and automatically assess code compliance for the building. In addition, the SMARTcodes™ may accessed manually by users through web-based interfaces to provide output that is useful for a variety of purposes.

### CROSS-REFERENCE TO RELATED APPLICATION

This application is based upon and claims priority from U.S. Patent Provisional Application No. 60/960,355, filed Sep. 26, 2007, the contents of which are incorporated herein by reference in its entirety.

### FIELD OF THE INVENTION

The invention relates to systems, programs and methods for compliance checking with respect to building regulations (codes). More specifically, these are systems, programs and methods to automate, with respect to building regulations, creation, storage and access to rule sets from the regulations to facilitate automated compliance checking of building plans and specifications against those regulations and to do so in a secure, technically accurate and reliable manner, and to collect and utilize building and system data submitted for compliance checking for a variety of purposes.

### BACKGROUND OF THE INVENTION

Historically, building regulations (codes) have been developed, adopted, implemented and enforced to ensure public safety and more recently have addressed issues such as energy efficiency, water use and sustainability. These codes, and standards that are referenced in the codes, are primarily developed in the voluntary sector (e.g. non-regulatory sector) and then adopted and applied by Federal, state and local governments as building rules and regulations. These building rules and regulations must be satisfied by building designers, owners, manufacturers, contractors and others involved in the design, construction, commissioning or operation of any aspect of a building and its systems. As used herein, the terms building regulations, regulations, rules, codes, and standards are used interchangeably and are each intended to include the body of criteria one must or is directed to follow in the design, construction, commissioning, operation and maintenance of buildings and their systems and component parts.

Traditionally, compliance with building regulations has been checked through review of plans and specifications (e.g. plan review) by code officials and fire service staff (e.g. authority having jurisdiction or AHJ) of the enforcing governmental entity to whom they are submitted. They are submitted by designers and others on behalf of the building owner or developer wishing to obtain a permit to construct a new building or remodel, renovate, add to or continue to operate and occupy an existing building. Traditionally those preparing designs and specifications for regulatory review and approval have had to determine compliance by reviewing and applying hard copies (e.g., print) of the adopted codes, standards and regulations, and in so doing regularly submitting non-compliant and/or incomplete documents to code officials for approval. Compliance checking (e.g. enforcement) beyond the review of plans and specifications, also involves construction inspections by building inspectors and the fire service. Such compliance and enforcement procedures and processes are critical, but are also time consuming and may not ensure a “correct by design” approach. In addition, code compliance verification that the designers typically conduct in advance of submission of plans and specifications to the AHJ can be incomplete or inaccurate as noted above but most critically review and compliance verification cannot be readily coordinated with the AHJ unless the designer and AHJ are in the same room working together, which is something that rarely happens. The current process is more series focused with considerable “back and forth” between all involved in the design team and all relevant AHJs with little use of Information Technology (IT) that can allow for a collaborative or more circular and transparent process.

With the advent of powerful computer aided design software and data standards such as industry foundation classifications (IFCs), all involved in the design and construction of buildings and preparation of specifications are able to exchange building information (data) in standard formats that facilitate the design and architectural rendering of buildings and their systems and component parts. Companies that make such software include Autodesk, Graphisoft and Bentley. Their software programs allow anyone to develop a data file referred to as a building information model (BIM) that is a digital representation of all the data associated with a building, both design, as built and as operated, that can be used by separate model checking software (MCS), or BIM software that also contains MCS to, among others provide three- and four-dimensional views of buildings that can be used by the architectural, engineering and construction (AEC) community to visualize the building. The availability of a BIM for a building makes it possible for all the different participants in the building design, construction, operations and approval process to all view, use, and act upon the building data and also provides vendors to the AEC industries a new place to provide information on the equipment, materials, or products that they provide for buildings.

The creation and use of CAD (computer aided design) tools for building designers facilitates the design and construction of buildings and was a significant breakthrough in the 1980's. Some efforts to date have been made to check CAD designs against building regulations or codes in an automated way, primarily by scanning the 2-D CAD drawings, but it is difficult at best to combine numerous different 2-D drawings into a 3-D virtual presentation of the resultant building and its systems and components. However, to date, no comprehensive and interoperable system relying on IFCs has been developed for fully automating code compliance checking of a building against relevant building codes and/or regulations, CAD or otherwise. Nor does any system exist where all Federal, state or local building codes and/or regulations can be accessed and used as a basis for automated compliance checking. To address the shortcomings of a manual code check process, limited by human capability, and allow for application and use of current IT there exists, for example, an opportunity for a comprehensive tool to integrate building codes and regulations in effect for one or more jurisdictions and make them available in an electronic format so they can be applied by MCS to a building as represented by a BIM to validate the building design meets adopted codes and regulations and if not meeting them to show why not. There remains a further need for such a tool to be able to define requirements and particularly the most restrictive requirements for one or more aspects of a building across multiple jurisdictions where the building designer or owner wants to apply the design in multiple jurisdictions or a product manufacturer wants to know how their product is impacted by rules in multiple jurisdictions. There remains a further need to integrate building code requirements with BIM authoring software tools to allow automated checking of building features against regulatory requirements as BIMs are created in a comprehensive and secure manner and where necessary in a manner that can be administered and controlled by code officials and the fire service.

### SUMMARY OF THE INVENTION

A protocol and software program are provided to create tagged representations of the ICC model building construction codes, sometimes referred to herein as SMARTcodes™(a trademark of the International Code Council), that have a tagging schema that reflects the logic and requirements of the ICC's codes, from “clean” xml files of the codes. The protocol and software can also be used to create “smart” versions of Federal, state, and locally adopted versions of those codes, as well as reference standards and any other rules or regulations. The SMARTcodes™ and embedded schema and tags are usable, when presented as a limiting rule set, by model checking software (MCS) as a limiting, or model, set of constraints when the MCS reads a building information model (BIM) that contains information about a building to check the building against the SMARTcodes™ and automatically assess code compliance for the building. In addition, the SMARTcodes™ may be accessed manually (by SMARTcodes QUERY™, a trademark of the International Code Council) by users through web-based interfaces to provide, in addition to information related to code compliance, output that is useful for a variety of purposes, such as answers to specific questions about the codes and code compliance, code criteria applicable to a topic, compliance checklists, product listing directories, code interpretations, etc. In addition “horizontal searches” identifying model code and Federal, state and local differences for each topic represented in codes can be conducted to facilitate assessing the impact of variation in codes on a particular material or product. The latter supports national companies that sell products that are used in multiple places with different codes and regulations.

According to one embodiment of the invention, a method or protocol is used to define how to create SMARTcodes™ from simple code text and through builder software (SMARTcodes™ builder software) allow tagging of the code requirements in xml format that will allow for automated code compliance checking. According to the method, SMARTcodes™ builder software (SCB) receives model code (or any other criteria) text in xml format and, using a guiding protocol, one familiar with the codes identifies in the text required checks and any applications (e.g. scope), requirements and exceptions in the code within the check. The builder then embeds the necessary schema corresponding to the applicabilities, requirements and exceptions in the code text to make the text “smart”. The code text is presented in an xml format, including a header and unique information identifying the SMARTcodes™ such as author and date of creation. The SMARTcodes™ further includes a method of describing each “apply,” require,” or “exception” within a check with respect to the topic, property, comparator or value information and units associated with the check. A check is also referred to as a code atom. To facilitate application of the SMARTcodes™ by model checking software, a rule set is created from the SMARTcodes™ by a rule processor that can reside as part of the trusted source of SMARTcodes™ or can reside as part of the model checking software.

According to another embodiment of the invention, to facilitate access to a reliable and trusted source of SMARTcodes™, SMARTcodes™ and associated compliance checking software may be stored, maintained and updated within a trusted entity that is accessed through a network. Such a trusted entity, for example and not limitation, can be a pre-certified source for performing the features of the SMARTcodes™ rule builder 140 and/or the model checking software 215, optionally with secured password access. Amendments or additions/deletions made to any model codes (or standards or regulations) by an adopting entity may be put in a tagged “smart” format and stored in the SMARTcodes™ database as amendments (or standard or regulation), rather than recreating entirely new SMARTcodes™, to reflect the revised code, standard or regulation as a whole.

For compliance checking, building information models (BIM) may be conveyed to a model checking software (MCS) application that in turn has access to the trusted entity and can apply the SMARTcodes™ directly to the BIM where the model checking software has its own rule processor, or to the resultant rules provided by the trusted entity from the SMARTcodes™ and provide automated compliance checking of the building as represented by the BIM against the applicable codes. The results of the compliance checking may be conveyed back to those who created the BIM via the MCS in a report or by updating the BIM via the MCS with data to reflect the results of the compliance check. The MCS can also print out a compliance report for manual use and application. The SMARTcodes™may also be made available to allow for a manual code search (SMARTcodes QUERY™) for use in manual compliance checking and the generation of various reports, such as delineation of requirements of particular codes or code sections; generation of inspection checklists for use during field inspection associated with code compliance; horizontal searches of code sections to determine whether any jurisdictions, such as Federal, state or local governments have amended any special code criteria; vertical searches to determine which codes are applicable a building project; and other purposes associated with building design, construction, operation, and maintenance in relation to codes, standards or regulations.

### BRIEF DESCRIPTION OF THE FIGURES

The above described features and advantages of embodiments of the present invention will be more fully appreciated with reference to the accompanying Figures, in which:

FIG. 1 depicts block diagram of a system for creating SMARTcodes™ according to an embodiment of the present invention.

FIG. 2 depicts a block diagram of a system for checking a building information model (BIM) against SMARTcodes™ in a trusted entity according to an embodiment of the present invention.

FIG. 3 depicts an illustrative SMARTcodes™ database having “smart” criteria corresponding to baseline model codes, standards and other criteria and amendments to those criteria on a Federal, state and locality level according to an embodiment of the present invention.

FIG. 4 depicts a block diagram of a system for automatically checking a building information model against SMARTcodes™ for code compliance and for using SMARTcodes™ to provide additional information manually on request to a user regarding the codes as represented by SMARTcodes™ according to an embodiment of the present invention.

FIG. 5 depicts a method of creating a SMARTcodes™ database according to an embodiment of the present invention.

### DETAILED DESCRIPTION

According to the present invention, a protocol and software program (SMARTcodes™ builder) are provided to assist those familiar with the codes or other criteria to create tagged representations of codes, standards, regulations and other building-related criteria that have a tagging schema that reflects the logic and requirements of the subject documents. These tagged representations are also referred to as SMARTcodes™. The SMARTcodes™ and embedded schemas are usable by model checking software (MCS) programs as a rule set or set of constraints or limits to allow one to automatically check a building as represented by a building information model (BIM) that stores information about a building to be automatically checked for compliance against the applicable criteria (code, standards, rules, regulations, etc.) as represented by the SMARTcodes™. The rule set needed by the MCS can be provided within the MCS so the MCS can directly apply SMARTcodes™ from the trusted entity, or the trusted entity can apply a rule processor and deliver the desired rule set to the MCS. In addition, the SMARTcodes™ may be manually assessed directly by users through user interfaces that will allow, in addition to automated code checking against a BIM, output that is useful for a variety of purposes, such as answers to specific questions about the codes, code criteria applicable to a specific topic, code compliance checklists and access to product literature and listing directories, code commentary and any other related information. Such interfaces may also provide access to “horizontal searches” identifying model code criteria and Federal, state and local code criteria for each topic represented in codes to facilitate assessing the impact of variation in codes on a design that may be repeated in multiple jurisdictions. The latter would be useful for companies such as Walmart or Marriott that build the same basic building in multiple jurisdictions and/or companies that sell products, materials or systems used in the federal sector or in multiple states or localities where codes may vary.

To facilitate a description of the invention, a glossary of terms is provided.

Applicability—The portion of an atom that captures a distinct precondition for applying a requirement, by defining a characteristic of the elements to which the code requirement or check applies.

Atom(s)—A testable element defining a criterion that can be used for compliance checking using information from a BIM, from the user or from a waiver or self-certification.

Attribute—A distinct slot that helps express the semantics of a check or atom.

Building Information Model (BIM)—Information in digital format that characterizes some or all aspects of a building and/or its systems, component parts or environment.

BIM Authoring Software (BIM ASW)—Software that provides the vehicle by which a BIM is created and can be maintained.

Check(s)—A single checkable section or subsection of a SMARTcodes™ code (e.g., a record), having a distinct identifier and topic and at least one requirement or subsidiary check.

Comparator—An operator or operation that drives a test for compliance (i.e., is less than).

Concept—Elements, properties, and units from the AEC domain that can be implemented as program objects or methods.

Dictionary—A collection of multilingual definitions, terms and synonyms grouped by a common concept. The dictionary may include functional definitions of the relationships between concepts and their representation within various schema.

Element—A named physical or abstract concept in the AEC domain.

Exception(s)—The portion of an atom that captures a distinct exception from the code requirements or a check.

Href—A check can reference a remotely held code document by reference to the path to the document and the ID of the remote code check. This may be useful, for example, when a check offers an alternative for code compliance.

ID—A distinct identifier, either within the codes or a single check. It is used for traceability and for application and generation, testing and quality control as well as connection of federal, state or local atoms to model code atoms.

Local id—A distinct identifier on an atom within a check. It is used for traceability, and reporting of the exact atom that has caused success or failure for a check.

Property—A physical property (e.g. permeance) associated with the topic of an atom, or a measurable quantity associated with an element.

Ref—A check reference to a nearby check within a code document. This, for example, may be useful when an introductory check identifies which other checks are applicable. This warns the schema checking applications Requirement(s)—The portion of an atom that captures a distinct requirement applicable to the building or a part of the building, usually an expectation.

Selection(s)—The portion of an atom that captures one of a district selection of choices typically by defining a type (among many) of the elements to which the check applies.

Select—This allows the grouping together of Applicabilities within a check because they are closely related.

SMARTcodes™—Tagged codes created from model codes or Federal, state or local amendments additions, or deletions to the model codes in any tag or markup language, such as hypertext markup language (html) or xml, that uses tags or other indicia to identify attributes within a document for specific treatment. The SMARTcodes™ may be written in any format, html or xml formats are examples, and include special tags or other indicia that correspond to concepts, elements, properties, units and other attributes that are specific to the subject codes. SMARTcodes™ may also include “smart” versions of standards and regulations. SMARTcodes™.

Topic—A description of the subject to which the particular segment of code text applies (e.g. water vapor retarder). It occurs on a check, where it is used to title reports and on atoms where it is used to identify the relevant element.

Unit—A qualification of a value of a property of an element, where there are multiple systems available (i.e., foot, meter . . . ).

Value—The specific value that is found in the code, whether true or false, a match, maximum or minimum.

to check the target, identified by a matching attribute id=, rather than this element.

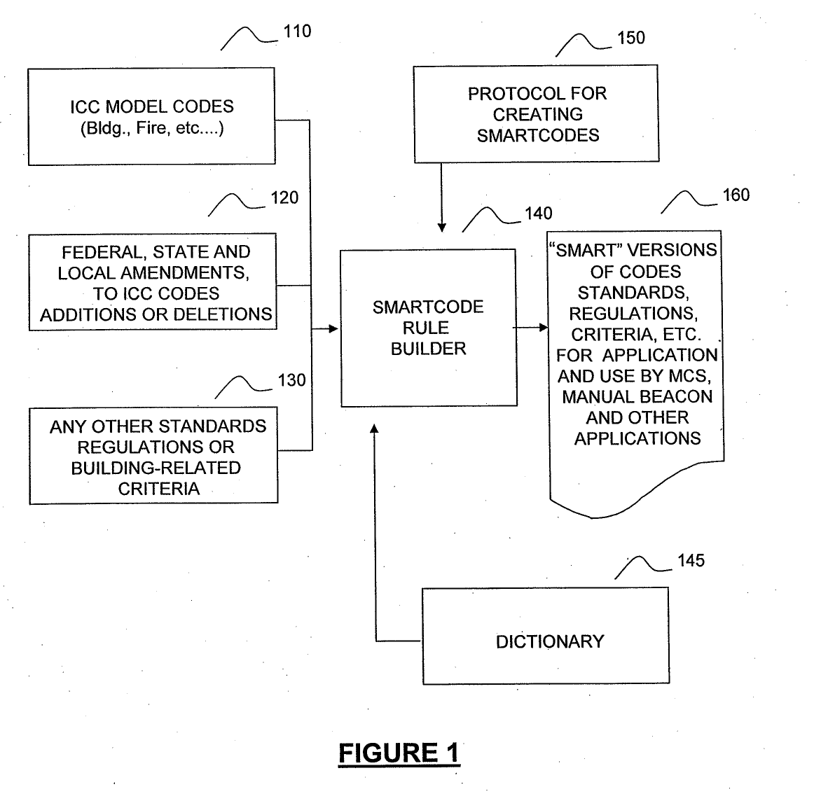

FIG. 1 depicts a block diagram of an illustrative system for generating SMARTcodes™, including codes, standards, regulations, etc. according to an embodiment of the invention. Referring to FIG. 1, the system includes inputs 110-130 to a SMARTcodes™ builder (builder) 140, which is used along with a protocol 150 to create smart versions of the codes (or other documents such as standards or regulations) 160, that reflect standards and criteria with schema and tags used for smart applications such as automated code checking. The inputs to the builder 140 include model codes themselves, such as those available from ICC or other model code creation or publishing entities; Federal, state and local amendments additions or deletions to the model codes 120, and any other standards, regulations or building related criteria 130. The inputs also rely on dictionaries 145 which are used by the builder 140 pursuant to the protocol 150 to facilitate creating the tags corresponding to a schema for SMARTcodes™. The dictionaries may include definitions of terms, descriptions of object models, data types, permissible units and operators. The dictionaries may further include schema information that correlates the SMARTcodes™ tags within the schema with the elements, units, operators and other information that make up the schema that is reflected in the SMARTcodes™ and that is ultimately correlated with information on a building design stored in a BIM that is checked against at least one of the SMARTcodes™ by model checking software.

The inputs upon which SMARTcodes™ are created may be stored in any convenient format, including in word processing formats, in ASCII format, or in publishing formats or tagged language or compressed formats but must first be put into clean xml format before they are used in the builder 140. In general, the inputs include information representing the text of the model codes, amendments and additions and deletions to those codes, reference standards as well as other rules, regulations or criteria that apply to buildings in different geographic areas.

The builder 140 receives the inputs as clean xml and with the use of the protocol 150 by someone familiar with the input (code provisions) allows them to create SMARTcodes™. For example, a user of the system can specify through the protocol(s) 150 that particular codes or code sections should take precedence over others. The builder 140 is a software program that may be implemented by a general purpose computer, with a processor, memory, storage devices, network connections and input/output devices, including graphical user interface displays and printers for generating output reports. The builder 140 may receive the inputs directly from memory or a storage device or over a network. In general, the builder 140 implements a protocol 150 for creating the SMARTcodes™, which is generally implemented in computer software instructions, residing on electronic memory and/or media, that are executed by the computer as given by the user of the builder 140.

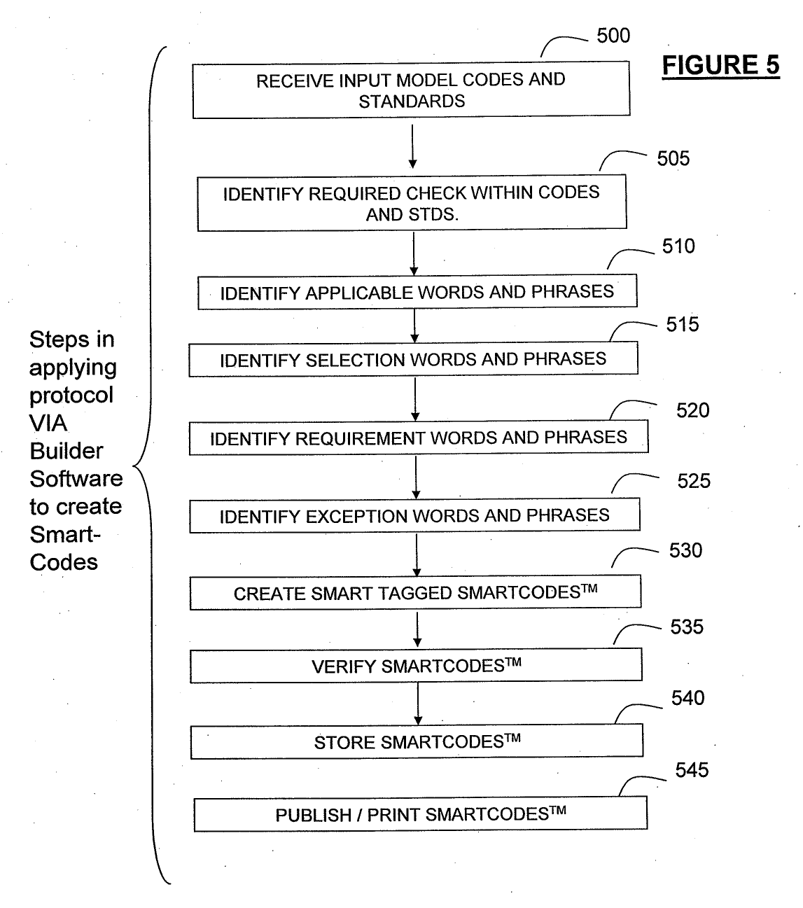

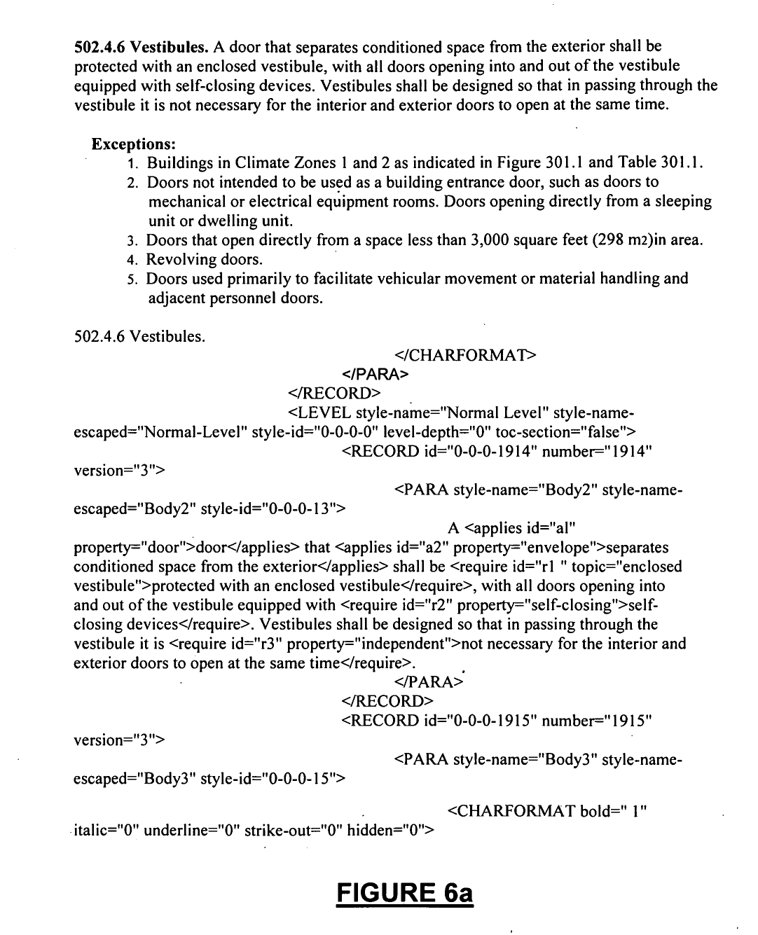

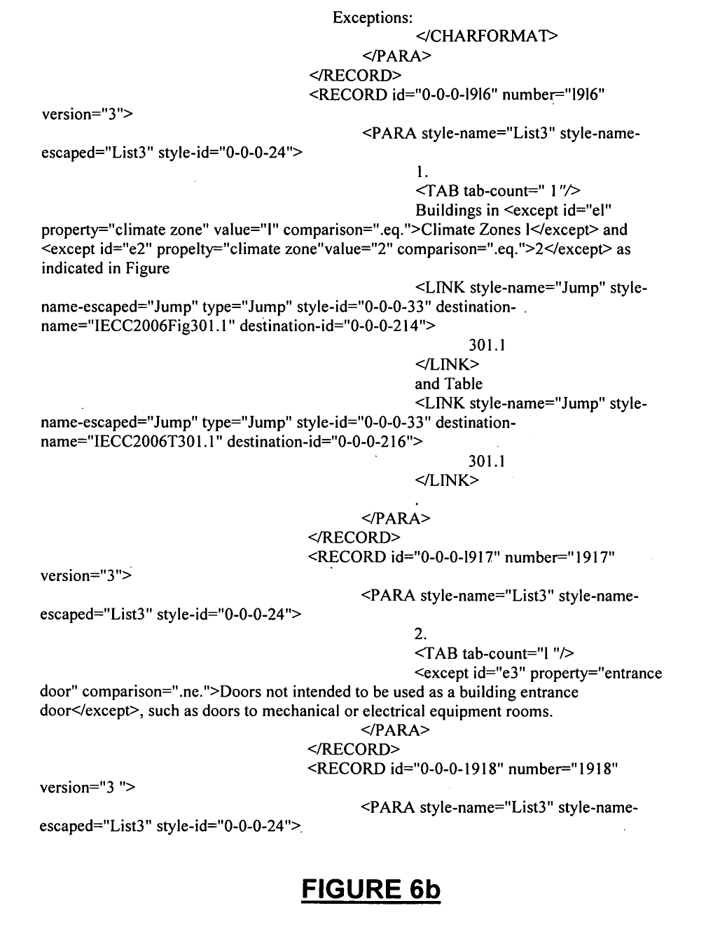

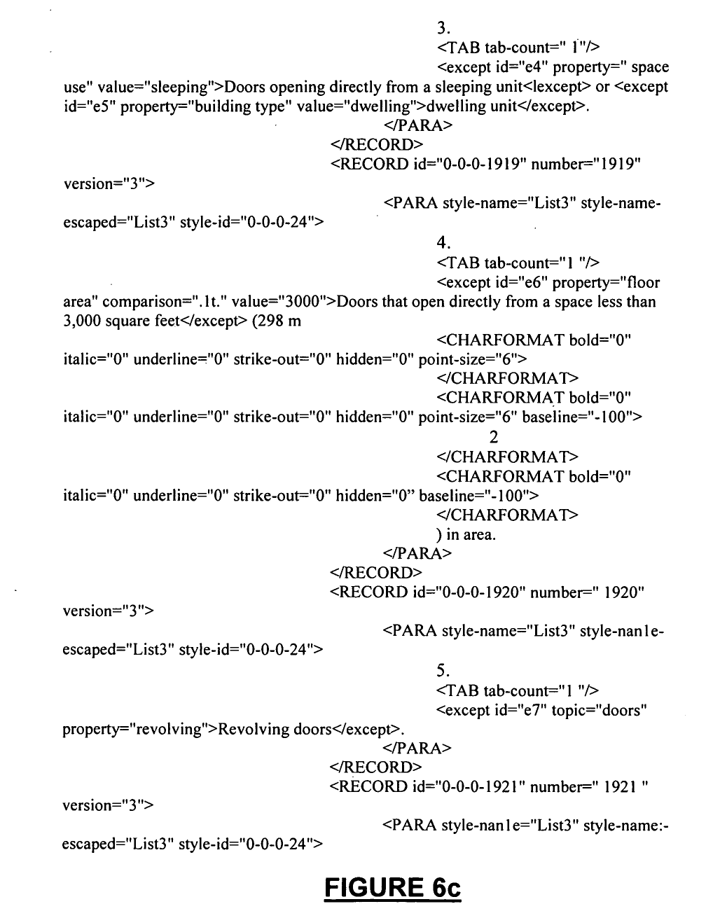

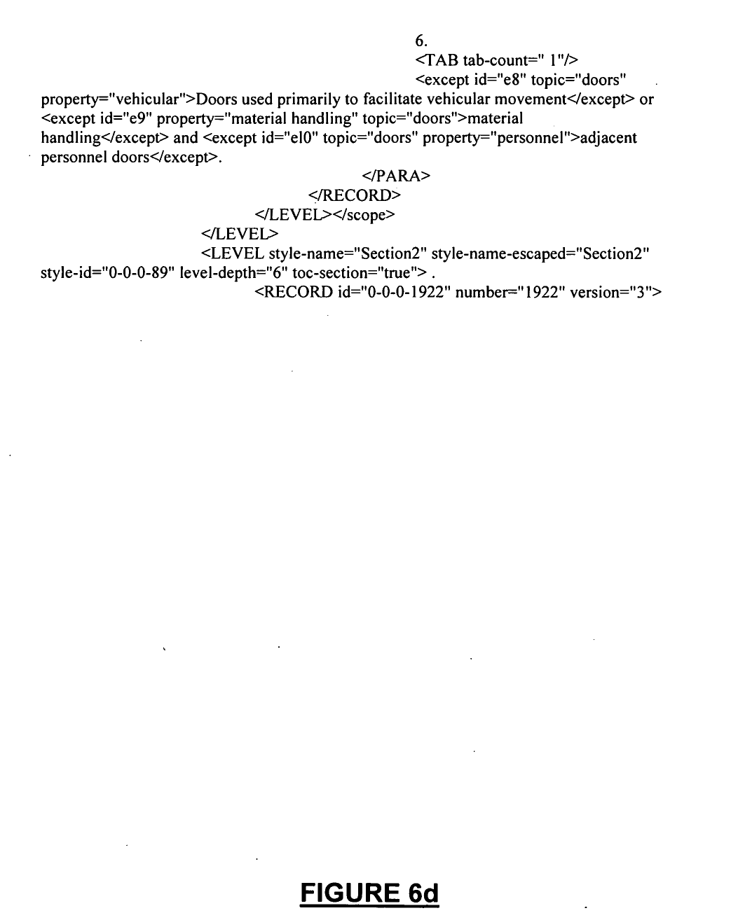

An illustrative method run by the builder 140 for creating the SMARTcodes™ using the protocol 150 is shown in FIG. 5. Referring to FIG. 5, in step 500, the user inputs the clean xml of code and regulation documents into the builder 140, for example from a specific xml file or a database accessible locally or over a network. In step 505, the rule builder 140 as guided by the protocol 150 identifies the provisions in a specific model code section that gives rise to required checks. These checks correspond to a code section or subsection that contains a specific requirement or related groups of requirements that must be applied to the BIM to determine if the building as represented by the BIM complies with the requirements.

In step 510, the applicability phrases or words within a check are identified. The applicability words or phrases are terms or a set of items that are generally identified individually, and their presence within a BIM renders the Check applicable to the BIM. This feature can be as viewed as applicable words or phrases as a statement of scope associated with a check. In step 515, the selection words or phrases within the code text associated with a check are identified. In step 520, the words or phrases associated with the requirements in a check are identified and coded in a tagged format. The requirements have a subject and objective. Where requirements have multiple alternatives, these alternatives are all coded or tagged as such. The objective may be a simple existence of the subject or it may be a property name, target or comparator. In step 525, the builder is used to identify any exceptions to the check, which are conditions under which the check is not applicable to the building as represented by the BIM. The exceptions are identified with a subject and an objective. The objective may be a simple existence of the subject or it may be a property name, target or comparator.

Once the atoms are created via steps 510-525, in step 530, the tagged text is created in xml (or other identified format) according to the dictionary and schema identified in the dictionary and schema 140. In this regard, the checks and atoms identified as requirements of the code are coded according to the schema. An exemplary building code section and examples of corresponding SMARTcodes™ in an xml format and schema according to an embodiment of the invention are shown, beginning in the next paragraph below. In general, the SMARTcodes™ include pairs of tags surrounding some text, beginning with an opening tag <x> and ending with </x>. If there is no text within the tags, then the pair may be abbreviated, for example n<x/>. The name of the tag is included in the opening and closing tag and tags may be compound to qualify the meaning of a tag: <x y=“z”>. The SMARTcodes™ generally include a header that identifies the tag format used, such as xml, SMARTcodes™xml or another format, including but not limited to the tagged format(s) described herein.

Exemplary building code section and text:

502.4.6 Vestibules. A door that separates conditioned space from the exterior shall be protected with an enclosed vestibule, with all doors opening into and out of the vestibule equipped with self-closing devices. Vestibules shall be designed so that in passing through the vestibule it is not necessary for the interior and exterior doors to open at the same time.

### Exceptions:

1. Buildings in Climate Zones 1 and 2 and indicated in FIG. 301.1 and Table 301.1.

2. Doors not intended to be used as a building entrance door, such as doors to mechanical or electrical equipment rooms. Doors opening directly from a sleeping unit or dwelling unit.

3. Doors that open directly from a space less than 3,000 square feet (298 m2) in area.

4. Revolving door.

5. Doors used primarily to facilitate vehicular movement or material handling and adjacent personnel doors.

502.4.6 Vestibules.

</CHARFORMAT>

</PARA>

</RECORD>
<LEVEL style-name=″Normal Level″ style-name-

escaped=″Normal-Level″ style-id=″0-0-0-0″ level-depth=″0″ toc-section=″false″>

<RECORD id=″0-0-0-1914″ number=″1914″

version=″3″>

<PARA style-name=″Body2″ style-name-

escaped=″Body2″ style-id=″0-0-0-13″>

A <applies id=″al″

property=″door″>door</applies> that <applies id=″a2″ property=″envelope″>separates
conditioned space from the exterior</applies> shall be <require id=″r1 ″ topic=″enclosed
vestibule″>protected with an enclosed vestibule</require>, with all doors opening into
and out of the vestibule equipped with <require id=″r2″ property=″self-closing″>self-
closing devices</require>. Vestibules shall be designed so that in passing through the
vestibule it is <require id=″r3″ property=″independent″>not necessary for the interior and
exterior doors to open at the same time</require>.

</PARA>

</RECORD>
<RECORD id=″0-0-0-1915″ number=″1915″

version=″3″>

<PARA style-name=″Body3″ style-name-

escaped=″Body3″ style-id=″0-0-0-15″>

<CHARFORMAT bold=″ 1″

italic=″0″ underline=″0″ strike-out=″0″ hidden=″0″>

Exceptions:

</CHARFORMAT>

</PARA>

</RECORD>
<RECORD id=″0-0-0-1916″ number=″1916″

version=″3″>

<PARA style-name=″List3″ style-name-

escaped=″List3″ style-id=″0-0-0-24″>

1.
<TAB tab-count=″ 1”/>
Buildings in <except id=″el″

property=″climate zone″ value=″1″ comparison=″.eq.″>Climate Zones 1</except> and
<except id=″e2″ propelty=″climate zone″value=″2″ comparison=″.eq.″>2</except> as
indicated in Figure

<LINK style-name=″Jump″ style-

name-escaped=″Jump″ type=″Jump″ style-id=″0-0-0-33″ destination-
name=″IECC2006Fig301.1″ destination-id=″0-0-0-214″>

301.1

</LINK>
and Table
<LINK style-name=″Jump″ style-

name-escaped=″Jump″ type=″Jump″ style-id=″0-0-0-33″ destination-
name=″IECC2006T301.1″ destination-id=″0-0-0-216″>

301.1

</LINK>
.

</PARA>

</RECORD>
<RECORD id=″0-0-0-1917″ number=″1917″

version=″3″>

<PARA style-name=″List3″ style-name-

escaped=″List3″ style-id=″0-0-0-24″>

2.
<TAB tab-count=″1 ″/>
<except id=″e3″ property=″entrance

door″ comparison=″.ne.″>Doors not intended to be used as a building entrance
door</except>, such as doors to mechanical or electrical equipment rooms.

</PARA>

</RECORD>
<RECORD id=″0-0-0-1918″ number=″1918″

version=″3 ″>

<PARA style-name=″List3″ style-name-

escaped=″List3″ style-id=″0-0-0-24″>

3.
<TAB tab-count=″ 1″/>
<except id=″e4″ property=″ space

use″ value=″sleeping″>Doors opening directly from a sleeping unit<lexcept> or <except
id=″e5″ property=″building type″ value=″dwelling″>dwelling unit</except>.

</PARA>

</RECORD>
<RECORD id=″0-0-0-1919″ number=″1919″

version=″3″>

<PARA style-name=″List3″ style-name-

escaped=″List3″ style-id=″0-0-0-24″>

4.
<TAB tab-count=″1 ″/>
<except id=″e6″ property=″floor

area″ comparison=″.1t.″ value=″3000″>Doors that open directly from a space less than
3,000 square feet</except> (298 m

<CHARFORMAT bold=″0″

italic=″0″ underline=″0″ strike-out=″0″ hidden=″0″ point-size=″6″>

</CHARFORMAT>
<CHARFORMAT bold=″0″

italic=″0″ underline=″0″ strike-out=″0″ hidden= ″0″ point-size=″6″ baseline=″−100″>

2

</CHARFORMAT>
<CHARFORMAT bold=″0″

italic=″0″ underline=″0″ strike-out=″0″ hidden=″0”baseline=″−100″>

</CHARFORMAT>
) in area.

</PARA>

</RECORD>
<RECORD id=″0-0-0-1920″ number=″ 1920″

version=″3″>

<PARA style-name=″List3″ style-nan1e-

escaped=″List3″ style-id=″0-0-0-24″>

5.
<TAB tab-count=″1 ″/>
<except id=″e7″ topic=″doors″

property=″revolving″>Revolving doors</except>.

</PARA>

</RECORD>
<RECORD id=″0-0-0-1921″ number=″ 1921 ″

version=″3″>

<PARA style-nan1e=″List3″ style-name:-

escaped=″List3″ style-id=″0-0-0-24″>

6.
<TAB tab-count=″ 1″/>
<except id=″e8″ topic=″doors″

property=″vehicular″>Doors used primarily to facilitate vehicular movement</except> or
<except id=″e9″ property=″material handling″ topic=″doors″>material
handling</except> and <except id=″e10″ topic=″doors″ property=″personnel″>adjacent
personnel doors</except>.

</PARA>

</RECORD>

</LEVEL></scope>

</LEVEL>
<LEVEL style-name=″Section2″ style-name-escaped=″Section2″

style-id=″0-0-0-89″ level-depth=″6″ toc-section=″true″> .

<RECORD id=″0-0-0-1922″ number=″1922″ version=″3″>

The codes may also include the original model (or other) code or standard text together with html or other tagging information and the SMARTcodes™ xml, which permit indexing, characterization and checking to the logical requirements specified in the code. By introducing the tagging into the code close to (or associated with) the original text of the code, this facilitates linking the original code text to the requirements so that users can read the original text corresponding to requirements as represented by the SMARTcodes™if they desire and also leads to expanded applications of “SMARTcodes™.”

Examples of tags include:

<check...> .... </check ...>
<check id = “ICC_IECC2006_502_5” topic = “Moisture Control”> ....
</check ...>;
<require...> . . . </require...>
<require local id = “r2” topic = “vapor retarder” property = “permeance”
comparison =
“.le.” value = “1” unit = “perm”> ...</require...>
<apply...> . . . </apply...>
<apply local id = “a1” property = “framed” </apply...>
<select...> . . . </select...>
<select local id = “s1” topic = “wall” </select...>
<except...> . . . </except...>
<except local id = “e1” property = “ventilated” </except...>

Attributes are also used to give meaning to each code atom. Attributes include id, local id, topic, property, comparison, value, unit, select, ref, href. A check is generally given a topic to permit error messages to be generated when a check fails. For example a check for a vapor retarder would be tagged as <require topic=“vapor retarder” . . . > . . . </require>. If this requirement is not met or the check fails, the error message generated based on the tags is easily generated, “requirement . . . on vapor retarder . . . was not met.” Similarly a property may be tagged <require property=“permeance” . . . > . . . </require>. If this property is not met, the tags are used to generate an error report during use of the SMARTcodes™ by model checking software “requirement . . . for permeance . . . was not met.” Comparisons may be coded <require comparison=”.le.” . . . > . . . </require> which when not met generates the error message “requirement . . . less than or equal to . . . not met.” Similarly, values and units may be coded <require . . . unit=“perm” . . . > . . . </require> and <require . . . value=“1.0” . . . > . . . </require>, respectively, which when not met generate the error messages, “requirement . . . perm units . . . was not met,” and “requirement . . . a value of 1.0 . . . was not met.” In this manner, non-compliance errors can be output in a meaningful manner from the Model Checking Software 215.

Waivers and self-certifications may be required by some checks. For example, a check may be met via self certification if “approved materials” are used. Values may be assigned to tags to accommodate such things, including by setting the values to be “believed,” “certified,” “approved,” or “waived” as examples. These values may be used to check against compliance within the model checking software. The SMARTcodes™ or “smart” criteria, including the tags generated, are stored for later use. The SMARTcodes™ include headers, the original code text and tags embedded in the original code text. The ID and local id tags correlate the rules with each code and make each check and atom within a check accessible to model checking software.

In step 535, the SMARTcodes™ are verified or checked to ensure functionality. After checking and verifying syntax within the SMARTcodes™ themselves (e.g. QC of SMARTcodes™ representation), the verification generally involves five checks:

1. Checking to make sure a concept is recognized by the model checking software. This may involve updating the dictionary used by and embedded in the builder to add a new concept so that the model checking software will recognize it or adding the concept to the model checking software, depending on how the model checking software is configured.

2. A concept may be recognized by the model checker, but fall into a category that is un-checkable, because it relates to future events such as inspection that takes place after a review of the building plans, or requires an opinion or certificate by someone subsequent to a review of the plans and specifications. This may be unavoidable and, according to one embodiment of the invention, the model checker is configured to log “not checkable at design review” items for building officials (or other users) to follow up on.

3. A concept may be recognized by the model checking software and correctly reflected in the dictionary, but the format of the BIM may not include data that is properly formatted for the check. This may be fixable through a dictionary update to correlate information from a BIM to the concept or it may require that BIM software authors add additional information to the BIM authoring software or BIM authors using such software so that the check can be performed.

4. The concept may be checkable but the BIM may use units that are not found in the comparison provided. This may be fixed by coding several units or by requiring BIM software authors to use standard units.

5. Each concept should be checked independently before use to ensure that it returns appropriate values.

In step 540 the SMARTcodes™may be stored to a database. In step 545, the codes represented by the SMARTcodes™ optionally may be published as written and adopted. In the publication step the xml associated with the SMARTcodes™ is not used in deference to “publishing’ xml that allows for presentation and printing of the code as written and adopted.

Additional information may also be generated for a variety of purposes. For example, a table of concepts may be generated that includes a list of checks and atoms associated with each check. This shows the SMARTcodes™in a different, systemic light. A constraint model may be generated that is stored in a file that is usable by code checkers, such as Solibri and AEC3-Checker (XABIO). The constraint model is a concise representation of the logic of the code, standard or regulation in a form intended to be used as data for these applications. The constraint model may be used to display the code as a hierarchical tree, starting from the document root and fanning out into the individual check and individual metrics. This report shows whether the document has been correctly coded as a single checkable tree. Any unattached sub-trees represent a problem that needs to be resolved.

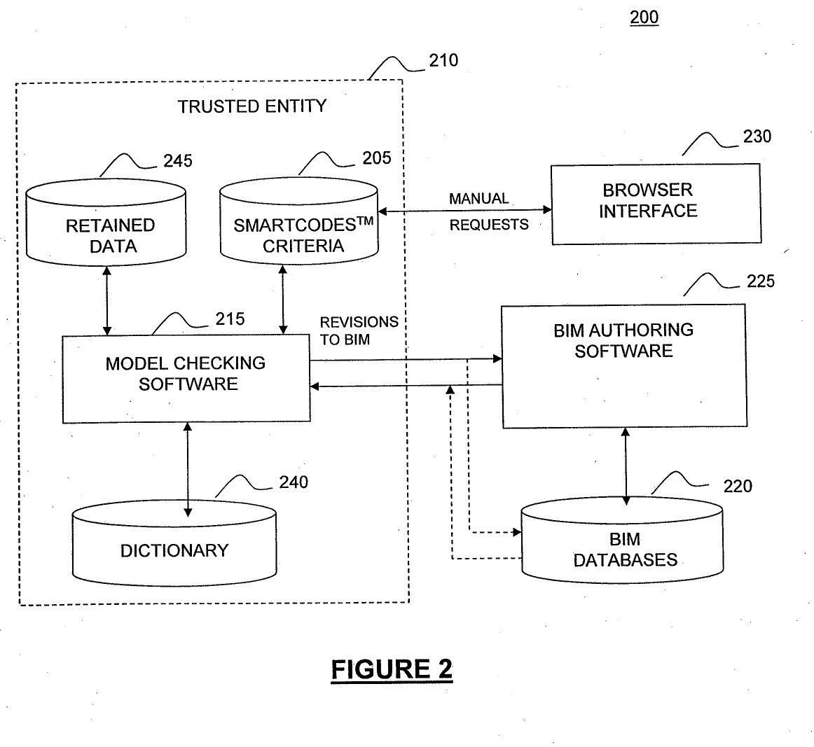

FIG. 2 depicts a block diagram of a system 200 for checking a building as represented by a BIM against adopted codes, standards, rules, regulations, etc. presented as SMARTcodes™ in a trusted repository according to an embodiment of the present invention. Referring to FIG. 2, a trusted entity 210 is used to store SMARTcodes™ 205, model checking software 215 and one or more dictionaries 240. The trusted entity is configured to receive a BIM from the BIM software 225 or a BIM database 220, to check the compliance of the BIM against applicable codes, standards and regulations, and return revisions to the user of the trusted entity in the form of needed revisions to the BIM.

The BIM software 225 is an authoring tool that is used by architects, engineers, code officials, contractors, and manufacturers and others to present data for building or structure design and/or products, materials and systems used in a building. The users interact with the BIM authoring software on the user's PC. The BIM authoring software (BIM ASW) allows the user to write the information describing the design of a building to a BIM file created on their PC by the BIM authoring software and as such create and visualize the building and its systems and components.

There are several companies that provide BIM authoring software including Autodesk, Bentley and Graphisoft. In addition, the format of the data in the BIM itself is subject to various standardization processes. For example, the buildingSMART Alliance, addressed at www.nibs.org, which is a Council of the National Institute of Building Sciences (NIBS), is leading an initiative in the United States called buildingSMART that sets a goal simplifying access to and use of building information. Under NIBS a national BIM standard has been developed that provides a standard to guide the uniform creation and presentation of BIMs.

During operation, the builder 140 and protocol 150 are used to keep a database of SMARTcodes™, standards, etc. criteria 205 up to date with current versions of relevant model codes, Federal, state and local amendment to those codes, standards, regulations etc. Thus, the database of SMARTcodes™, etc. 205 is a comprehensive database concerning all design, construction and operational aspects of a building or structure from a building regulatory standpoint from a federal, state and local vantage point. While it is desirable for the database of SMARTcodes™, tagged language, etc. 205 to be as comprehensive as possible with respect to different codes, standards, and regulations and the scope of what may be checked within each code, it is also possible to have multiple trusted entities where each maintains a database that is more focused or targeted on other criteria (e.g. green, sustainable, provisions beyond minimums code etc.). It is also possible to have separate databases within a single trusted entity that target different codes, standards, regulations, design guides, rules, manuals, etc (e.g. criteria applicable to buildings).

The model checking software interfaces with the user's PC and receives requests for services and/or building data (BIM). The model checking software interacts with the “smart” criteria, the received BIM and the dictionaries 240 in order to perform the requested action related to code compliance. As discussed above, the processor that creates the rules from the SMARTcodes™ can either be part of the trusted entity and deliver the rules to the model checking software 215, or the model checking software 215 can have its own rule processor that takes the SMARTcodes™ and creates the needed rule set. One example of a rule processor is available through AEC3 Ltd. The model checking software can be PC based or server based and may further include features to authenticate users, track usage for purposes of code checking and charge users for their use of the SMARTcodes™. One example of model checking software is Solibri Model Checker by Solibri, Inc. Techniques for authentication and usage tracking are well known. The trusted entity may be coupled to the BIM software directly or via a network connection, which may be a secure section such as an SSL connection.

Alternatively, the model checking software may be accessible via a browser interface which allows users to log in and submit searches, requests for information or submit BIMS for code compliance checking. In at least one embodiment, the system and method for determining compliance with building regulations can be fully automated, with the SMARTcodes™ builder 140 receiving known and/or selected regulations, the BIM authoring software 225 receiving data associated with a building(s) or property to be checked for compliance, and the model checking software 215 receiving all required and/or desired inputs and generating compliance and/or non-compliance output, reports, and/or warnings.

Examples of functionality of the model checking software are described below.

### EXAMPLE 1

### Automated Code Check

The creator or reviewer of a BIM (user) desires to check the design, construction or operations of a building or a portion of a building against relevant codes, standards and regulations (e.g. criteria). The user sends a request to the trusted entity along with their data (BIM) to check the relevant BIM data against all relevant criteria. Such checks can be performed at all stages of building and/or property development, from design through construction phases and further through subsequent changes and remodeling. The model checking software receives the BIM and the request and, based on the location of the building coded in the BIM, determines the SMARTcodes™ relevant to the building to check the BIM against for compliance. The model checking software 215 also uses the dictionary 240 to establish any necessary correlation between the database schema of the BIM and the “smart” criteria. If the BIM is not compatible with the SMARTcodes™ based on the dictionary or the BIM does not contain needed data, an error message is generated and an indication that checking cannot be performed is provided. If the SMARTcodes™ and BIM are compatible, then the model checking software applies the “smart” criteria and, using the relevant rule set (constraint model) performs each required check against the corresponding data from the BIM. The model checking software logs each check that satisfies the criteria, produced an error showing noncompliance or that could not be performed because of missing data or some other issue, such as a waiver or self certification.

The model checking software returns to the user information that reflects the errors, including code criteria that are not satisfied or specific language from codes that is not met. This may be conveyed in a file with text that the MCS may display as text as well as 3D and 4D visuals of the building with areas of non-compliance identified and explained to the user through the user interface. Alternatively, the BIM ASW may allow the user to update the BIM to consider information from the codes that is not satisfied by the BIM. The updated BIM may then be displayed to the user by the BIM ASW and the user may interact with the BIM software to find or review the errors. In this way, BIM software users may run code checks on codes while creating a BIM, identify errors at any time during the design or building process and seek to make changes to the building design as represented by the BIM to fix the code compliance problems. Similarly, AHJs may also run automated checks on BIMs submitted for regulatory approval to facilitate their review and approval of building plans and specifications.

### EXAMPLE 2

### SMARTcodes QUERY™

The trusted entity may also respond to requests for information about codes that are part of an automated compliance request or simply a manual request from someone that does not have a BIM. For example, users may send requests to the trusted entity for information about code provisions applicable to a specific item or issue associated with their building, and also access code commentary, interpretations and related educational materials, product listing directories, reference standards and any other resource information relevant to their request. These requests do not have to come from BIM software and may be received, for example, from users via a browser interface 230.

The requests might also ask for all relevant code sections about a topic. Alternatively, a request might specify a vertical search—an identification of all relevant codes for a particular jurisdiction and/or federal customer. A request might specify a horizontal search—an identification of particular criteria across the federal, state and/or local level applicable to a particular issue or product.

### EXAMPLE 3

### Building Activity Reports

The trusted entity may also retain information in a retained information database on buildings that are undergoing code compliance checking. For example, the retained BIM data stored in the database 245 might include portions of BIMs that have useful information such as the address of new buildings, project schedules, the type of building and systems and any other useful information. The information retained in the retained BIM data database becomes more useful over time and may be used to generate reports on construction activity during certain time periods or types of products or materials being specified and to provide other statistics about building in one or more geographic areas or on certain building types. The retained information database may be made searchable to users through a browser interface or may be used to generate reports.

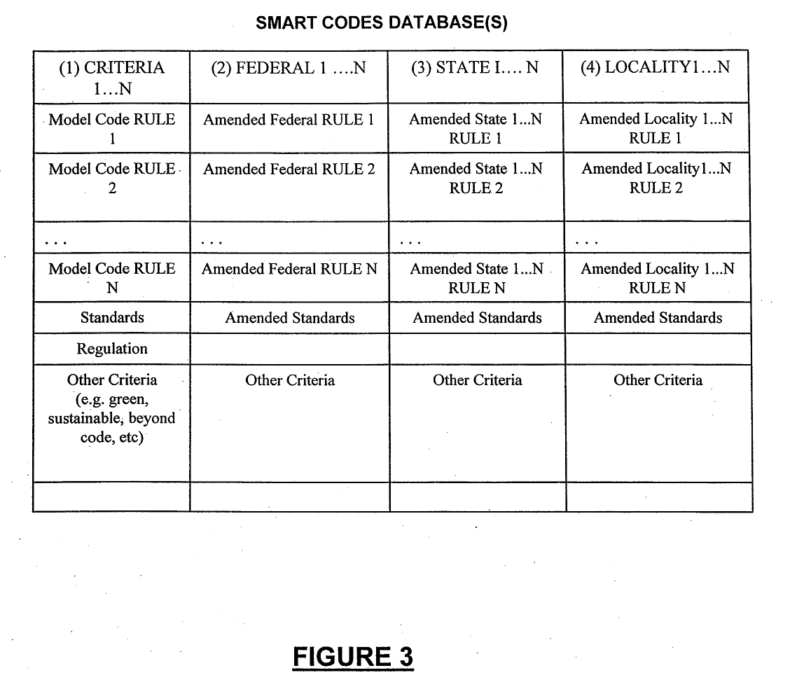

FIG. 3 depicts an illustrative SMARTcodes™ database (or “smart” criteria database 205). Referring to FIG. 3, the database includes criteria, and in particular:
(1) “smart” model codes, “smart” standards, “smart” regulations (e.g. zoning) and other criteria such as green, sustainable, insurance and beyond code;
(2) federal amendments to model codes, standards, regulations and other criteria;
(3) state amendments to model codes, standards, regulations and other criteria; and
(4) local amendments to model codes, standards, regulations and other criteria.

Model codes may be adopted by different states or localities for state/local government owned or private sector consideration or the federal government for purposes of federal building construction, with amendments, additions and deletions. Rather than create SMARTcodes™corresponding to the adopted version of each code at the Federal, state or local level, according to one embodiment of the invention, the database(s) are structured so that only code sections or sections of standards that have been revised or amended upon Federal, state or local adoption are stored in the database. It will be understood, however, that a “smart” or tagged version of any model code may also be created and used consistent with the information provided herein. The ID fields and local id fields within the SMARTcodes™ are used to create implicit correlations between rules in model codes and amendments to those same rules by the federal government, states and localities. In this way any international or national model code or standard, or Federal, state or locally adopted version of those documents can be represented in a tagged format and used as a basis for automated code checking or manual code search as described herein.

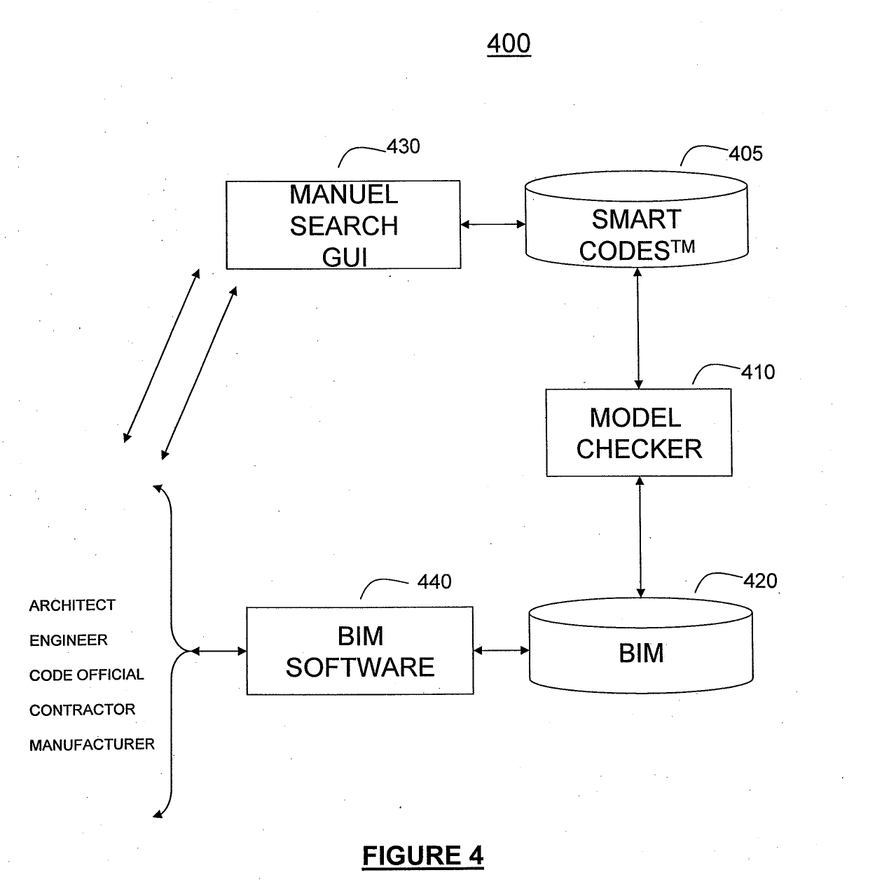

FIG. 4 depicts another block diagram of a system 400 according to an embodiment of the present invention. Referring to FIG. 4, users such as engineers, architects, code officials and others are given access to the codes through automated and manual routes. In the automated routes, users use BIM software 440 to create or interact with BIM data stored in a BIM database 420 and MCS 410 to launch automated code checks against SMARTcodes™ database 405. With the automated code checks, the MCS 410 receives the request for compliance checking and the BIM (or portions of the BIM) from the database 420 and accesses the SMARTcodes™from the database 405 to ID those relevant to the project as represented by the BIM and to check the BIM against all requirements of those codes. The model checker 410 can then update the BIM in the BIM database 420 to reflect the results of the compliance check. These results are then displayed to the user through the BIM Software 440 and can be printed out as a compliance check, field inspection check list and any number of other outputs to address user needs.

With the manual checking, the user has an interface, shown as the manual search GUI 430, which may be a web page, through which the user interacts with the SMARTcodes™in the SMARTcodes™ database 405, such interaction being presented as a SMARTcodes QUERY™. The user is able to request information about model codes, including performing horizontal searches, vertical searches, generate checklists for codes, code sections or concepts and otherwise retrieve useful information about the codes and how they apply to particular issues or questions they have associated with their building. The requested information is returned to the user through the manual search GUI 430.

The described system, processes, protocols, and methods include and implement the technical aspects and considerations of the computer/processor/network-based system and devices described herein and in the figures, whereby the unique processing, decision-making, information gathering and recording and transmission, and communications of exemplary embodiments work together for the effective determination of whether or not a property or a building is in compliance with relevant building regulations, whether the regulations be federal, state, or local—all by notice to a user through presentation on a display or a printed report of through information transmitted across a network to remote users and interested parties. Accordingly, exemplary systems and methods as described herein provide a tangible and technical effect of determining property and building code compliance, based on existing regulations and BIM models.

While specific embodiments of the invention have been shown and described, it will be understood by those having ordinary skill in the art that changes and enhancements may be made to those embodiments without departing from the spirit and scope of the present invention. That is, documents can be put in “smart,” tagged or other electronic files or formats and users can be given access to them manually (e.g. direct user interface) or automatically (e.g. via MCS and/or BIM ASW) for the purposes of providing value in the form of information and services related to building compliance with codes, standards and regulations. For example, while ICC model codes have been described herein, it will be understood that model codes and standards promulgated by other entities in any jurisdiction or in the voluntary sector may be coded using the techniques identified herein.

What is claimed is:

1. A method of generating electronic files for automated compliance checking, comprising:
receiving text from at least one of a code, standard and regulation;
identifying using software required checks based on the text;
identifying using the software any applicabilities, selections, requirements and exceptions associated with the checks;
creating using the software an electronic file based on the received text and the required checks; and
embedding tags in the electronic file corresponding to the text and the required checks using the software.

2. The method according to claim 1, further comprising:
storing the electronic file, including a header and information identifying the source of the text.

3. The method according to claim 1, further comprising:
generating and storing in the electronic file an identification of each check.

4. The method according to claim 1, wherein each check comprises at least one code atom that defines an aspect of the check and generating and storing a local id corresponding to each atom of a check.

5. The method according to claim 1, further comprising:
associating any topic, property, comparator and value information with tags for a check.

6. The method according to claim 5, further comprising:
associating units with the check.

7. The method according to claim 6, further comprising:
storing a reference tag within at least one check to another check or a check within another code, standard or regulation.

8. The method of claim 1, further comprising:
storing the electronic file in a trusted database; and
accessing the electronic file to compliance check a building information model for compliance with code.

9. The method of claim 8, further comprising:
updating a BIM based on the compliance check.

10. A computer program product including computer program logic stored in a storage medium for causing a computer to create a tagged electronic file from text within a code, standard or regulation, comprising:
computer program logic for causing a computer to receive text from at least one of a code, standard and regulation;
computer program logic for causing the computer to identify required checks based on the text;
computer program logic for causing the computer to identify using the software any applicabilities, selections, requirements and exceptions associated with the checks; and
computer program logic for causing the computer to create an electronic file based on the received text and required checks and to embed tags in the electronic file corresponding to the text and the checks.

11. The computer program product according to claim 10, further comprising:
computer program logic for causing the computer to store the electronic file, including a header and information identifying the source of the text.

12. The computer program product according to claim 10, further comprising:
computer program logic for causing the computer to generate and store in the electronic file an identification of each check.

13. The computer program product according to claim 10, wherein each check comprises at least one code atom that defines an aspect of the check and further comprising computer program logic for causing the computer to generate and store a local id corresponding to each atom of a check in the electronic file.

14. The computer program product according to claim 10, further comprising:
associating any topic, property, comparator and value information with tags for a check.

15. The computer program product according to claim 14, further comprising:
computer program logic for causing the computer to associate units with the check.

16. The computer program product according to claim 15, further comprising:
computer program logic for causing the computer to store a reference tag within at least one check to another check or a check within another code, standard or regulation.

17. The computer program product according to claim 10, further comprising:
computer program logic for causing the computer to store the electronic file in a trusted database; and
computer program logic for causing the computer to access the electronic file to compliance check a building information model for compliance with code.

18. The computer program product according to claim 17, further comprising:
updating a BIM based on the compliance check.

19. A system for checking compliance of a code, comprising:
a database that stores a tagged electronic file corresponding to a code, standard or regulation, wherein the electronic file includes text from the code, standard or regulation and tags associated with the text corresponding to required checks;
a database that stores a dictionary that correlates tags within the electronic file to information within a BIM;
a computer coupled to the databases, that includes software that receives BIM files and checks compliance of the BIM files against the tagged electronic files based on the required checks and identifies areas of non-compliance.

20. The system according to claim 19, wherein the computer receives the BIM files over a network from a second computer and further returns to the second computer over the network the identification of areas of non-compliance.

21. The system according to claim 20, wherein the computer receives the identification of the tagged electronic file to use for checking the BIM from the second computer.

22. The system according to claim 21, wherein the tagged electronic file includes required checks that vary based on jurisdiction and wherein the computer checks compliance for at least one jurisdiction.

23. The system according to claim 21, wherein the tagged electronic file includes required checks that vary based on jurisdiction and wherein the computer checks compliance for multiple jurisdictions and identifies the areas of non-compliance for each of the multiple jurisdictions.

24. The system according to claim 19, further comprising BIM authoring software used to create the BIM.

25. The system according to claim 24, wherein the BIM authoring software displays to the user a graphical indication of non-compliance based on the identified areas of non-compliance.

26. The system according to claim 19, further comprising code search software resident on the computer that allows a user to search the tagged electronic file for required checks corresponding to one or more code sections.

27. The system according to claim 26, wherein the search is across multiple jurisdiction.

28. The system according to claim 26, wherein the search is for a single jurisdictions.

29. The system according to claim 19, wherein the BIM authoring software is resident on the computer.

30. The system according to claim 20, wherein the BIM authoring software is resident on the second computer.

31. A computer program product including computer program logic stored in a storage medium for checking compliance of a code, comprising:
computer program logic for causing a computer to access a database;
wherein the accessible database stores a tagged electronic file corresponding to a code, standard or regulation, wherein the electronic file includes text from the code, standard or regulation and tags corresponding to required checks associated with the text, and stores a dictionary that correlates tags within the electronic file to information within a BIM; and
computer program logic for causing the computer to receive BIM files and check compliance of the BIM files against the tagged electronic files based on the required checks and dictionary and to identify areas of non-compliance.

32. The computer program product according to claim 31, wherein the computer program logic causes the computer to receive the BIM files over a network from a second computer and further returns to the second computer over the network the identification of areas of non-compliance.

33. The computer program product according to claim 32, wherein the computer program logic causes the computer to receive the identification of the tagged electronic file to use for checking the BIM from the second computer.

34. The computer program product according to claim 31, wherein the tagged electronic file includes required checks that vary based on jurisdiction and wherein the computer program logic causes the computer to check compliance for at least one jurisdiction.

35. The computer program product according to claim 31, wherein the tagged electronic file includes required checks that vary based on jurisdiction and wherein the computer program logic causes the computer to check compliance for multiple jurisdictions and identifies the areas of non-compliance for each of the multiple jurisdictions.

36. The computer program product according to claim 31, further comprising computer program logic that causes the computer to search the tagged electronic file for required checks corresponding to one or more code sections.

37. The computer program product according to claim 36, wherein the search is across multiple jurisdictions.

38. The computer program product according to claim 36, wherein the search is for a single jurisdiction.

39. The computer program product according to claim 19, further comprising computer program logic for causing the computer to create and display a BIM and the identified areas of non-compliance.

40. A system for determining compliance with building regulations, comprising:
at least one first electronic file comprising federal, state, and/or local regulations;
at least one second electronic file comprising descriptive data for a property and/or a structure;
electronic media comprising computer instructions for executing a smartcode rule builder and producing a rules protocol from the at least one first electronic regulations file;
electronic media comprising computer instructions for constructing a building information model from the at least one second electronic descriptive file; and
electronic media comprising computer instructions for executing model checking software, wherein input to the model checking software includes the results from the smartcode rule builder and the building information model,
wherein output from the model checking software determines whether the property and/or structure is in compliance with the federal, state, and/or local regulations.
